(19) United States
(12) Patent Application Publication
(10) Pub. No.: US 2007/0035717 A1
(43) Pub. Date: Feb. 15, 2007

(54) Contact lithography apparatus, system and method

(76) Inventors: Wei Wu, Palo Alto, CA (US); Shih-Yuan Wang, Palo Alto, CA (US); Zhiyong Li, Palo Alto, CA (US); Robert G. Walmsley, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/580,621

(22) Filed: Oct. 13, 2006

Related U.S. Application Data
(63) Continuation-in-part of application No. 11/203,551, filed on Aug. 12, 2005.

(51) Int. Cl. G03B 27/02

(52) U.S. Cl. 355/78

(57) ABSTRACT

A contact lithography system includes a patterning tool bearing a pattern; a substrate chuck for chucking a substrate to receive the pattern from the patterning tool; where the system deflects a portion of either the patterning tool or the substrate to bring the patterning tool and a portion of the substrate into contact; and a stepper for repositioning either or both of the patterning tool and substrate to align the pattern with an additional portion of the substrate to also receive the pattern. A method of performing contact lithography comprising: deflecting a portion of either a patterning tool or a substrate to bring the patterning tool and a portion of the substrate into contact; and repositioning either or both of the patterning tool and substrate to align a pattern on the patterning tool with an additional portion of the substrate to also receive the pattern.

### RELATED APPLICATION

The present application is a continuation-in-part and claims the priority of co-pending U.S. patent application Ser. No. 11/203,551, entitled “Contact Lithography Apparatus, System, and Methods” which is incorporated herein by reference in its entirety.

### BACKGROUND

Contact lithography involves direct contact between a patterning tool (e.g., a mask, mold, template, etc.) and a substrate on which micro-scale and/or nano-scale structures are to be fabricated. Photographic contact lithography and imprint lithography are two examples of contact lithography methodologies. In photographic contact lithography, the patterning tool (i.e., the mask) is aligned with and then brought into contact with the substrate or with a pattern-receiving layer of the substrate. Some form of light or radiation is then used to expose those portions of the substrate that are not covered by the mask so as to transfer the pattern of the mask to the pattern-receiving layer of the substrate. Similarly, in imprint lithography, the patterning tool (i.e., the mold) is aligned with the substrate after which the mold is pressed into the substrate such that the pattern of the mold is imprinted on, or impressed into, a receiving surface of the substrate.

With either method, alignment between the patterning tool and the substrate is very important. The method for aligning the patterning tool and substrate generally involves holding the patterning tool a small distance above the substrate while relative lateral and rotational adjustments (e.g., x-y translation and/or angular rotation adjustments) are made. Either the patterning tool or the substrate, or both, may be moved during the process of alignment. The patterning tool is then brought into contact with the substrate to perform the lithographic patterning. Imprint lithography or nanoimprint lithography is a methodology for forming micro-scale and nano-scale structures on a substrate.

As indicated, in imprint lithography, the patterning tool is aligned with the substrate and then brought into contact with a surface of the substrate with some force. Consequently, the pattern of the patterning tool is imprinted on or impressed into a receiving surface of the substrate. Unfortunately, during the imprint process, distortions often occur in the pattern as transferred to the receiving surface of the substrate. Mechanical deformations of the mold or substrate during the imprint process may distort the structures formed. For example, the flexure of a patterned region may cause patterns to become blurred, shifted, weakened, or otherwise distorted. Also, the shape, size, and density of features in a patterned area may limit the flow of photoresist or other chemicals used to form the structures, thereby causing the structures to be inconsistent, flawed, or absent.

### BRIEF DESCRIPTION OF THE DRAWINGS

The accompanying drawings illustrate various embodiments of the principles being described in this specification and are a part of the specification. The illustrated embodiments are merely examples and do not limit the scope of the principles described herein.

FIG. 1 illustrates a side view of a contact lithography apparatus according to principles described herein.

FIG. 2A illustrates a side view of an embodiment of the contact lithography apparatus of FIG. 1 having spacers formed as an integral part of a mask according to principles described herein.

FIG. 2B illustrates a perspective view of the mask illustrated in FIG. 2A according to principles described herein.

FIG. 2C illustrates a cross section of another embodiment of the contact lithography apparatus of FIG. 1 having spacers formed as an integral part of a substrate according to another embodiment of the principles described herein.

FIG. 2D illustrates a side view of a contact lithography apparatus according to principles described herein.

FIG. 3A illustrates a side view of a contact lithography apparatus according to principles described herein.

FIG. 3B illustrates a side view of the contact lithography apparatus of FIG. 3A in a closed configuration according to principles described herein.

FIG. 3C illustrates a side view of an embodiment of the contact lithography apparatus of FIGS. 3A and 3B in which mask flexure is employed according to principles described herein.

FIG. 3D illustrates a side view of another embodiment of the contact lithography apparatus of FIGS. 3A and 3B in which substrate flexure is employed according to principles described herein.

FIG. 3E illustrates a side view of an embodiment of the contact lithography apparatus of FIGS. 3A and 3B in which spacer deformation is employed according to principles described herein.

FIG. 3F illustrates a side view of an embodiment of the contact lithography apparatus of FIGS. 3A and 3B in which a spacer exhibiting plastic deformation is employed according to principles described herein.

FIG. 3G illustrates a side view of an embodiment of the contact lithography apparatus of FIGS. 3A and 3B in which deformable spacers are employed according to principles described herein.

FIG. 4 illustrates a block diagram of a contact lithography system according to principles described herein.

FIG. 5 illustrates an exemplary contact lithography device for performing a step-and-repeat lithography process to produce a number of identical units from a single substrate according to principles described herein.

FIG. 6 illustrates a cross section view of an exemplary operation of the contact lithography device of FIG. 5 according to principles described herein.

FIG. 7 further illustrates an exemplary operation of the contact lithography device of FIG. 5 according to principles described herein.

FIG. 8 illustrates a flow chart of an exemplary method of step-and-repeat contact lithography according to principles described herein.

FIG. 9 illustrates a flow chart of an exemplary method of separating a patterning tool and substrate following contact lithography according to principles described herein.

FIG. 10 illustrates another exemplary contact lithography device for performing a step-and-repeat lithography process to produce a number of identical units from a single substrate according to principles described herein.

FIG. 11 illustrates an exemplary patterning tool for use in a step-and-repeat contact lithography process according to principles described herein.

FIG. 12 illustrates a flow chart of an exemplary method of operating the contact lithography system of FIG. 10.

Throughout the drawings, identical reference numbers designate similar, but not necessarily identical, elements.

### DETAILED DESCRIPTION

The principles described herein facilitate patterning a substrate using lithography involving contact between a patterning tool and a substrate. In various examples, these techniques employ one or more spacers between the patterning tool and the substrate to establish a parallel and proximal alignment therebetween. The parallel and proximal alignment provided by the spacers is readily maintained during lateral and or rotational adjustments between the patterning tool and the substrate to establish a desired alignment of the tool and the substrate. In addition, according to various examples, a flexure or deformation of one or more of the patterning tool, the substrate, and the spacer facilitates the contact between the substrate and the patterning tool. Furthermore, the flexure-facilitated contact has little or no adverse effect on the previously established lateral and rotational alignment according to the principles described herein. These principles may also be adapted to a step and repeat contact lithography system and method that readily enable the production of numerous units on a single substrate

As used herein and in the appended claims, the term “deformation” refers to both a plastic deformation and an elastic deformation. As used herein, “plastic deformation” means an essentially non-reversible, non-recoverable, permanent change in shape in response to an applied force. For example, a “plastic deformation” includes a deformation resulting from a brittle fracture of a material under normal stress (e.g., a cracking or shattering of glass) as well as plastic deformations that occur during shear stress (e.g., bending of steel or molding of clay). Also, as used herein, “elastic deformation” means a change in shape in response to an applied force where the change in shape is essentially temporary and/or generally reversible upon removal of the force. The term “flexure” is considered herein to have the same meaning as “deformation,” and the terms are used interchangeably, as are “flex” and “deform,” “flexible” and “deformable,” and “flexing” and “deforming,” or the like.

As used herein and in the appended claims, the term “deformation” further generally includes within its scope one or both of a passive deformation and an active deformation. Herein, “passive deformation” refers to deformation that is directly responsive to an applied deforming force or pressure. For example, essentially any material that can be made to act in a spring-like manner either by virtue of a material characteristic and/or a physical configuration or shape may be passively deformable. As used herein, the term “active deformation” refers to any deformation that may be activated or initiated in a manner other than by simply applying a deforming force. For example, a lattice of a piezoelectric material undergoes active deformation upon application of an electric field thereto independent of any applied deforming force. A thermoplastic that does not deform in response to an applied deforming force until the thermoplastic is heated to a softening point is another example of active deformation.

Further, as used herein and in the appended claims, the term “contact lithography” generally refers to any lithographic methodology that employs a direct or physical contact between a patterning tool or means for providing a pattern and a substrate or means for receiving the pattern, including a substrate having a pattern receiving layer thereon. Specifically, ‘contact lithography’ as used herein includes, but is not limited to, any form of photographic contact lithography, X-ray contact lithography, and imprint lithography.

As mentioned above, and by way of example, in photographic contact lithography, a physical contact is established between a patterning tool, in this case called a photomask, and a photosensitive resist layer on the substrate (i.e., the pattern receiving means). During the physical contact, visible light, ultraviolet (UV) light, or another form of radiation passing through selected portions of the photomask exposes the photosensitive resist or photoresist layer on the substrate. The photoresist layer is then developed to remove portions that don't correspond to the pattern. As a result, the pattern of the photomask is transferred to the substrate.

In imprint lithography, the patterning tool is a mold that transfers a pattern to the substrate through an imprinting process. In some embodiments, physical contact between the mold and a layer of formable or imprintable material on the substrate transfers the pattern to the substrate. Imprint lithography, as well as a variety of applicable imprinting materials, are described in U.S. Pat. No. 6,294,450 to Chen et al. and U.S. Pat. No. 6,482,742 B1 to Chou, both of which are incorporated herein by reference in their respective entireties.

For simplicity in the following discussion, no distinction is made between the substrate and any layer or structure on the substrate (e.g., a photoresist layer or imprintable material layer) unless such a distinction is helpful to the explanation. Consequently, reference herein is generally to the “substrate” irrespective of whether a resist layer or an imprintable material layer is or is not employed on the substrate to receive the pattern. One of ordinary skill in the art will appreciate that a resist or imprintable material layer may always be employed on the substrate of any contact lithography methodology according to the principles being described herein.

FIG. 1 illustrates a side view of a contact lithography apparatus (100) according to principles described herein. The contact lithography apparatus (100) comprises a patterning tool or ‘mask’ (110) and one or more spacers (120). The contact lithography apparatus (100) copies, prints, or otherwise transfers a pattern from the mask (110) to a substrate (130). In particular, direct contact between the mask (1 10) and the substrate (130) is employed during pattern transfer.

In the contact lithography apparatus (100), the spacers (120) are located between the mask (110) and the substrate (130) prior to and during pattern transfer. The spacers (120) provide for and maintain an essentially parallel and proximal separation between the mask (110) and the substrate (130) and thus reduce problems of alignment and stability related to vibration and temperature. For example, in some embodiments, the mutual physical and thermal contact between the mask, the spacers and the substrate, during alignment may result in the mask and the substrate being at essentially the same temperature during the subsequent lithography, thus reducing alignment errors associated with temperature differences among the elements. In some embodiments, the mask, the spacers, and the substrate, being in physical contact, may react to vibration essentially as a single unit, thus reducing differential vibration-induced alignment errors that are present in conventional contact lithography systems.

The deformation of one or more of the mask (110), the spacers (120), and the substrate (130) facilitates the pattern transfer by enabling the mask (110) and the substrate (130) to contact one another. For example, in some embodiments, one or both of a flexible mask (110) and a flexible substrate (130) is employed. In another embodiment, a deformable (e.g., collapsible) spacer (120) is employed. In yet other embodiments, a combination of one or more of a flexible mask (110), a flexible substrate and a deformable spacer (120) are employed. In some embodiments, rigidity may be provided by a plate or carrier that supports one or both of the mask (110) and substrate (130) during pattern transfer, as described below. Pattern transfer occurs while the mask (110) and the substrate (130) are in direct contact as a result of the flexure and/or deformation.

In some embodiments, especially wherein flexure of one or both of the mask (110) and the substrate (130) are employed, the flexure may occur between or within a region encompassed or bounded by the spacers (120). For example, the spacers (120) may be located at a periphery of a patterned region of the mask (and/or an area to be patterned of the substrate) and the flexure of the mask (110) and/or the substrate (130) occurs within that periphery.

In some embodiments, for example when a deformable spacer (120) is employed, an essentially non-deformable mask (110) and/or an essentially non-deformable substrate (130) is used. For example, a semi-rigid or rigid mask (110) that is not deformed or not intended to be deformed during pattern transfer may be the non-deformable mask (110). Furthermore, when using the deformable spacer (120), one or more of the spacers (120) may be located within a broader patterned area or region. For example, the substrate (130) may be a wafer having a plurality of individual dice or chips defined thereon. The dice have respective local patterned areas. In this example, deformable spacers (120) may be located in spaces or regions between the local patterned areas of the wafer substrate (130). Spaces or regions between local patterned areas include, but are not limited to, ‘streets’ or ‘saw kerfs’ separating the individual dice on the wafer substrate (130).

In some embodiments, the spacers (120) are components separate from either the mask (110) or the substrate (130). In such embodiments, the spacers (120) are generally positioned, placed, or otherwise inserted between the mask (110) and the substrate (130) prior to establishing contact between the mask (110) and substrate (130) for the pattern transfer.

In other embodiments, the spacers (120) are formed as an integral part of one or both of the mask (110) and the substrate (130). For example, the spacers (120) may be fabricated as an integral part of the mask (110) in some embodiments. In other embodiments, the spacers (120) may be fabricated as an integral part of the substrate (130). In yet other embodiments, some of the spacers (120) may be formed as an integral part of one or both of the mask (110) and the substrate (130) while others of the spacers (120) are not integral to either the mask (110) or the substrate (130).

In some embodiments, the spacers (120) that are integral to either the mask (110) or the substrate (130) are formed by depositing or growing a material layer on a respective surface of either the mask (110) or the substrate (130). For example, a silicon dioxide (SiO₂) layer may be either grown or deposited on a surface of a silicon (Si) substrate (130). Selective etching of the deposited or grown SiO₂ layer may be employed to define the spacers (120), for example, resembling stand-off posts. In some embodiments, a uniform height of each of the stand-off post spacers (120) is established by virtue of a simultaneous growth or deposition of the spacers (120). For example, forming the spacers (120) simultaneously using an evaporative material deposition on the substrate (130) surface will generally result in each of the spacers (120) having essentially identical heights. Alternatively or in addition, post-processing of the grown and/or deposited spacers (120) such as, but not limited to, micro-machining (e.g., chemical-mechanical polishing, etc.) may be employed to further adjust and/or to provide for uniform height. Similar methods may be employed to form the spacers (120) on or as an integral part of the mask (110).

In yet other embodiments, the spacers (120) may be separately fabricated and then affixed to one or both of the mask (110) and the substrate (130) using glue, epoxy or other suitable means for joining. However, whether fabricated as an integral part of, or affixed to, one or both of the mask (110) or the substrate (130), the spacers (120) are so fabricated or affixed prior to performing contact lithography employing the contact lithography apparatus (100).

In some embodiments, the deformable spacer (120) may exhibit one or both of plastic deformation and elastic deformation. For example, in a plastic deformation of the deformable spacer (120), a deforming force may essentially crush or smash the spacer (120). After being crushed or smashed, little or no significant recovery of an original shape of the spacer (120) will result when the deforming force is removed. In another example, the deformable spacer (120) may undergo an elastic deformation in response to the deforming force. During elastic deformation, the spacer (120) may bend or collapse but the spacer (120) will essentially return to its original shape once the force is removed. An elastically deforming spacer (120) may comprise a rubber-like material or spring-like material/structure, for example.

In some embodiments, the deformable spacer (120) provides one or both of passive deformation and active deformation. A passively deformable spacer (120) may exhibit one or both of plastic and elastic deformation. Materials having a spring-like behavior suitable for use as passively deformable spacers (120) that exhibit elastic deformation include various elastomeric materials. In particular, the spacers (120) may comprise an elastomeric material such as, but not limited to, nitrile or natural rubber, silicone rubber, perfluoroelastomer, fluoroelastomer (e.g., fluorosilicone rubber), butyl rubber (e.g., isobutylene or isoprene rubber), chloroprene rubber (e.g., neoprene), ethylene-propylene-diene rubber, polyester, and polystyrene. Non-elastomeric materials that are formed in a manner that facilitates spring-like behavior during passive deformation may be employed as well. Examples of non-elastomeric materials that can be formed into springs for use as the spacers (120) include metals such as, but not limited to, beryllium copper and stainless steel as well as essentially any relatively rigid polymer. In addition, many conventional semiconductor materials may be micro-machined into mechanical spring configurations. Examples of such materials include, but are not limited to, silicon (Si), silicon oxide (SiO₂), silicon nitride (SiN), silicon carbide (SiC), gallium arsenide (GaAs), and most other conventional semiconductor materials. Such non-elastomeric materials formed as springs may be used to produce passively deformable spacers (120) that exhibit one or both of plastic and elastic deformation depending on the specific shapes and forces employed.

As with passively deformable spacers (120), the actively deformable spacers (120) may exhibit one or both of plastic deformation and elastic deformation. For example, the actively deformable spacer (120) may comprise a piezoelectric material having a crystal lattice that deforms in response to an applied electric field. The lattice deformation in response to the electric field may be used to provide the deformation of the spacer (120) in such exemplary embodiments instead of or in addition to an applied deforming force. Since the lattice deformation of a piezoelectric material essentially returns to an original shape once the applied electric field (i.e., deforming force) is removed, spacers (120) formed from such piezoelectric materials are considered herein to exhibit essentially elastic deformation.

In another example, the actively deformable spacer (120) may comprise an essentially hollow structure such as, but not limited to, a bladder or tube, that is filled with a fluid (e.g., one or both of a gas and a liquid) such that the spacer (120) resists deformation when filled. To activate deformation, the fluid filling the spacer (120) is removed, evacuated, or allowed to leak therefrom. As such, the spacer (120) essentially resists deformation under the deforming force until being activated by removing the filling fluid. Such a spacer (120) may exhibit either elastic or plastic deformation depending on whether the filling fluid is replaced in the hollow structure, for example. In yet another example, the spacer (120) may comprise a thermally activated material that changes shape and/or resiliency in response to a thermal stimulus. Examples of thermally activated materials include, but are not limited to, materials that melt, soften, or exhibit a glass transition at or above a particular temperature. A spacer (120) comprising such a thermally activated material is activated by heating the material above a melting point, a softening point or a glass transition point, depending on the embodiment. A thermoplastic is an example of such a thermally activated material that would exhibit an essentially plastic deformation as a result of activation by the thermal stimulus.

As discussed above, the deformable spacer (120) may provide a deformation that is essentially reversible (i.e., elastic deformation) or essentially irreversible (i.e., plastic deformation). In some embodiments, the deformable spacer (120) may provide a combination of plastic deformation and elastic deformation, depending on the embodiment. An example of a deformable spacer (120) that provides an essentially reversible or elastic deformation is an elastomeric spacer or a spring-like spacer, as described above, for example. An essentially irreversible or plastically deformable spacer (120) may be provided by a rigid or semi-rigid material wherein the spacer (120) comprising the material is crushed or collapsed by application of a deforming force. For example, the spacer (120) may comprise a porous semi-rigid material such as, but not limited to, polystyrene foam and polyurethane foam. Such porous semi-rigid foams may exhibit an essentially irreversible (i.e., plastic) deformation when a deforming force is applied. In another example, a relatively porous silicon dioxide (SiO₂) layer deposited on one or both of the mask (110) and the substrate (130) and formed as the post-like spacers (120) may provide a deformation that is essentially irreversible or plastic. In such embodiments, the post-like spacer (120) irreversibly or plastically deforms when a deforming force is applied that is sufficient to essentially crush the post-like spacer (120). Moreover, in some embodiments, the spacer (120) may comprise a combination of reversible and irreversible characteristics using a combination of materials and passive or active deformation, as described above.

Moreover, one or both of the mask (110) and the substrate (130) may be deformable. Moreover, the deformable mask (110) and/or the deformable substrate (130) may exhibit one or both of plastic or elastic deformation as defined hereinabove. Furthermore, the deformable mask (110) and/or substrate (130) may provide one or both of passive or active deformation as defined hereinabove. In some embodiments, one or both of the mask (110) and substrate (130) may comprise materials described above with respect to the spacer (120) to achieve one or more of elastic, plastic, passive and active deformations.

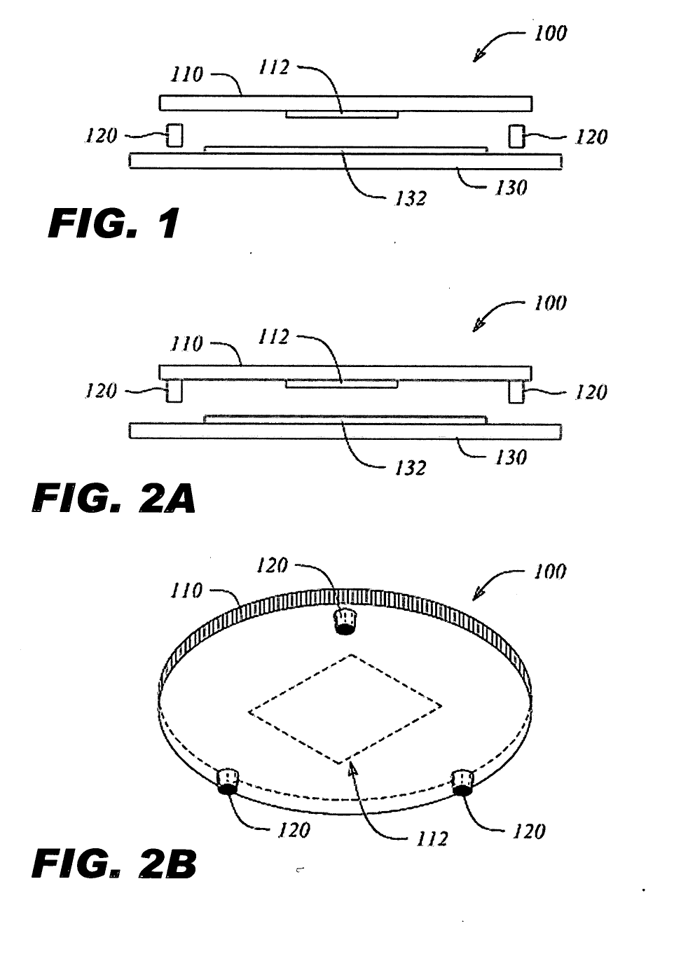

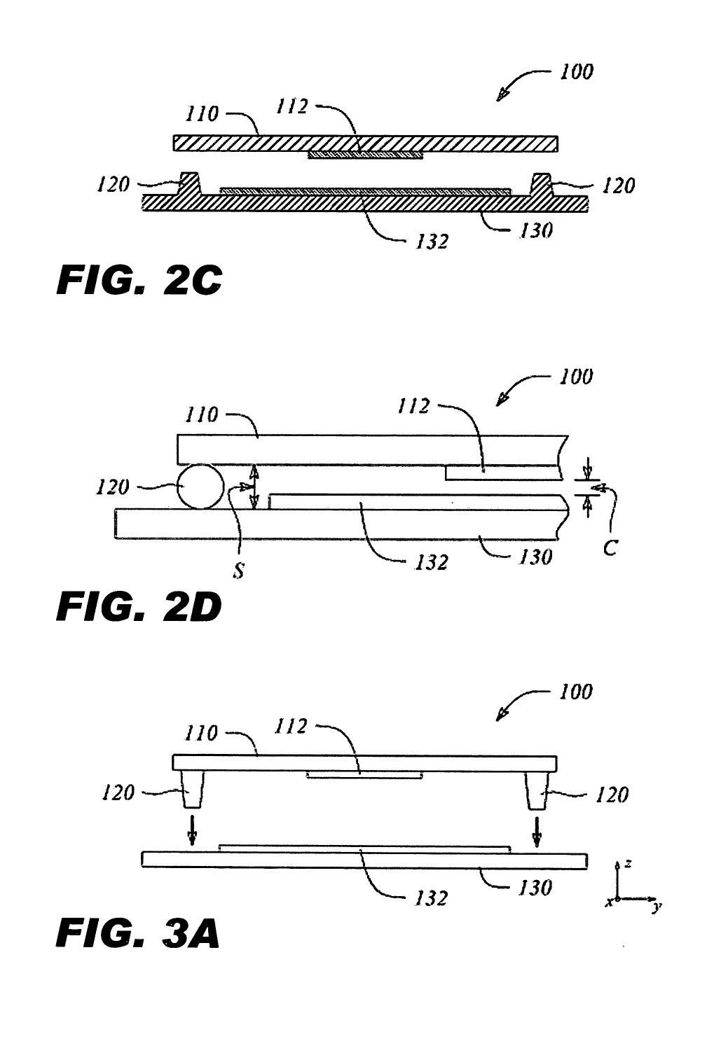

FIG. 2A illustrates a side view of the contact lithography apparatus (100) of FIG. 1 wherein the spacers (120) are formed as an integral part of the mask (110) according to principles described herein. FIG. 2B illustrates a perspective view of the mask illustrated in FIG. 2A according to principles described herein. In particular, as illustrated in FIG. 2B, three spacers (120) depicted as stand-off posts or pillars are formed on or in a surface of the mask (110).

FIG. 2C illustrates a cross sectional view of the contact lithography apparatus (100) of FIG. 1 wherein the spacers (120) are formed as an integral part of the substrate (130) according to another embodiment of the principles described herein. For example, the spacers (120) may be fabricated as an integral part of the substrate (130) using conventional semiconductor fabrication techniques including, but not limited to, one or more of etching, deposition, growth, and micromachining.

Whether separately provided or fabricated (i.e., formed) as part of one or both of the mask (110) and the substrate (130), in some embodiments, the spacer (120) comprises a precisely controlled dimension. Specifically, the spacer (120) may be fabricated with a precisely controlled dimension for spacing apart or separating the mask (110) and the substrate (130). As used herein, the term ‘spacing dimension’ refers to a dimension of the spacer (120) that controls the separation between the mask (110) and the substrate (130) when the spacers (120) are employed in the contact lithography apparatus (100).

For example, a height of each of the three spacers (120) in FIG. 2B may be precisely controlled during fabrication of the spacers (120). As a result, when the spacers (120) act together to separate the mask (110) from the substrate (130), the separation takes on a precisely controlled spacing dimension equal to the height of the spacers (120). Moreover, in the example, if the heights of the spacers (120) are all essentially equal to one another, the mask (110) and the substrate (130) are not only separated by the spacers (120) but also are aligned essentially parallel to one another by the separating action of the spacers (120). For example, parallel alignment of the mask (110) and the substrate (130) may be achieved by employing the spacers (120), as illustrated in FIG. 2B with essentially identical heights.

Another embodiment of the spacing dimension is a diameter of the spacer. For example, the diameter of a spacer (120) having a circular cross section may be the spacing dimension. Examples of such a spacer (120) with a circular cross section include, but are not limited to, a rod, an O-ring and a sphere. By controlling the diameter of the spacers (120), a parallel alignment of the mask (110) and the substrate (130) may be achieved when the mask (110) and the substrate (130) are in mutual contact with and separated by the spacers (120) with a circular cross section. In some embodiments, the spacer (120) having a circular cross section has a shape of a ring or loop, such as a circle, semi-circular, rectangle or square, wherein a cross sectional diameter of the ring spacer (120) is uniformly equal about a perimeter of the ring. Such ring-shaped spacer (120) may surround an edge of the mask (110) and the substrate (130), as further described below.

In some embodiments, when employed in the contact lithography apparatus (100), the spacers (120) are located outside of (i.e., peripheral to) a patterned area of the mask (110) and/or an area of the substrate (130) that is to be patterned (i.e., target area or portion). For example, the spacers (120) may be located at or near an edge (i.e., periphery) of one or both of the mask (110) and the substrate (130). In other embodiments, the spacers (120) are located other than at the edge or periphery of the mask (110) or the substrate (130). For example, the spacers may be located between patterned areas (e.g., in saw kerfs between local patterned regions), as described above.

For example, referring again to FIG. 2B, a patterned area (112) of the mask (110) is illustrated as an exemplary rectangular area bounded by a dashed line. The post-shaped spacers (120) illustrated in FIG. 2B are outside of the patterned area (112). Moreover, referring to FIG. 2C, a target portion or area (132) of the substrate (130) is illustrated on the substrate (130) surface. The post-shaped spacers (120) illustrated in FIG. 2C are outside of the target portion (132) of the substrate (130) as well as the patterned area (112) of the mask (110). As used herein, ‘target portion’ or ‘target area’ refers to that portion of the substrate (110) that receives a copy of a mask pattern as represented by the patterned area (112) of the mask (110).

In some embodiments, the spacers (120) are positioned to roughly align with corresponding areas on the mask (110) and/or the substrate (130) that have a minimum local relief or otherwise few if any pattern features. Locating the spacers (120) in areas having few if any pattern features, such as beyond a patterned area or area being patterned, reduces interference between the spacers (120) and the patterning being performed using the contact lithography apparatus (100) in some embodiments, while in other embodiments, ensures a minimal interference therebetween.

Herein, ‘local relief’ refers to a feature height, wherein ‘feature’ is defined below. In general, the feature height is less than the spacing dimension of the spacer (120) to avoid contact between patterned areas of the mask (110) and the substrate (130) prior to deformation. “Minimum local relief” means any areas of the mask (110) and the substrate (130) that have minimum feature heights. In other words, areas of the mask (110) and/or the substrate (130) exhibiting minimum local relief are areas that contain essentially minimal protrusions (positive or negative) from a nominal planar surface of respectively either the mask (110) or the substrate (130). By positioning the spacer (120) to align with areas of minimum local relief, the spacers (120) are able to slide on a contact surface during alignment without adversely affecting the spacer-provided parallel and proximal relationship of the mask (110) and the substrate (130).

In some embodiments, the spacers (120) provide a spacing dimension (i.e., proximal relationship) in the range of about 0.01 to 50 microns (μm). In other embodiments, the spacers (120) provide a spacing dimension in a range of 0.1 to 10 microns (μm). In yet other embodiments, the spacers (120) may provide essentially any spacing dimension that befits a particular contact lithography situation or application.

FIG. 2D illustrates a side view of the contact lithography apparatus (100) according to principles described herein. In particular, FIG. 2D illustrates the spacers (120) acting to separate the mask (1 10) from the substrate (130) by the spacing dimension S. The exemplary spacers (120) illustrated in FIG. 2D have a circular cross section, by way of example, and may be provided separately from the mask (110) and the substrate (130) in some embodiments.

In some embodiments, the spacing dimension of the spacers (120) is greater than a maximum combined height of features of the mask (110) and/or the substrate (130). By ‘feature’ it is meant any protrusion (positive or negative) from a nominal planar surface of either the mask (110) or the substrate (130), excluding the spacers (120). A feature height is an extent to which a feature of either the mask (110) or the substrate (130) extends above or away from the nominal surface thereof. In such embodiments, the spacers (120) produce a separation between a maximum height of all features on the mask (110) and a maximum height of all features on the substrate (130) when employed as intended in the contact lithography apparatus (100). In other words, the spacers (120) provide a clearance between the maximum height features of the mask (110) and the substrate (130). As illustrated in FIG. 2D, the clearance C provided by the spacers (120) essentially insures that a highest feature of the mask (110) clears or is spaced apart from a highest feature of the substrate (130).

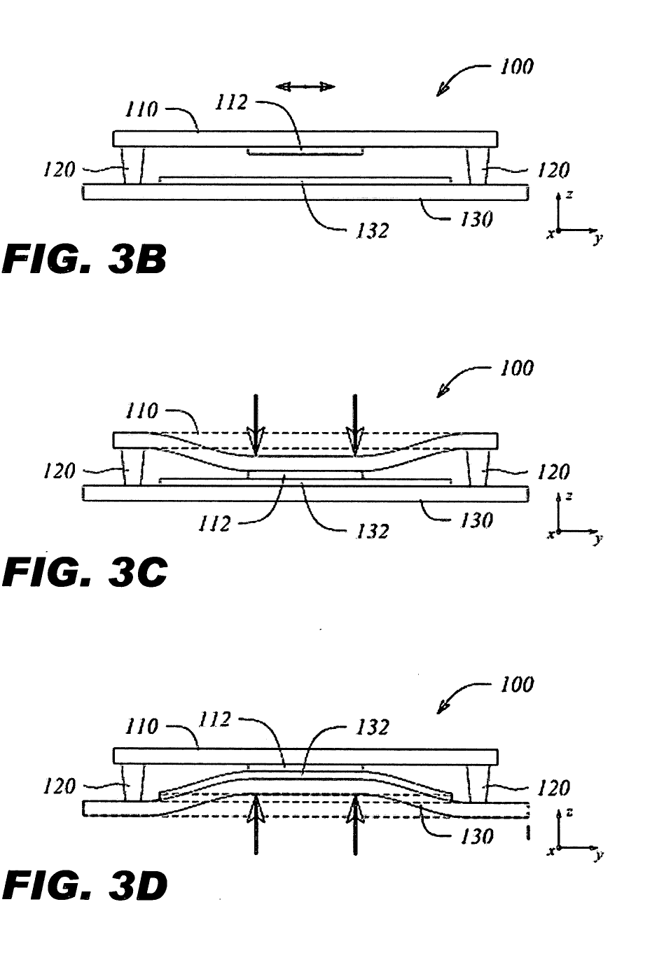

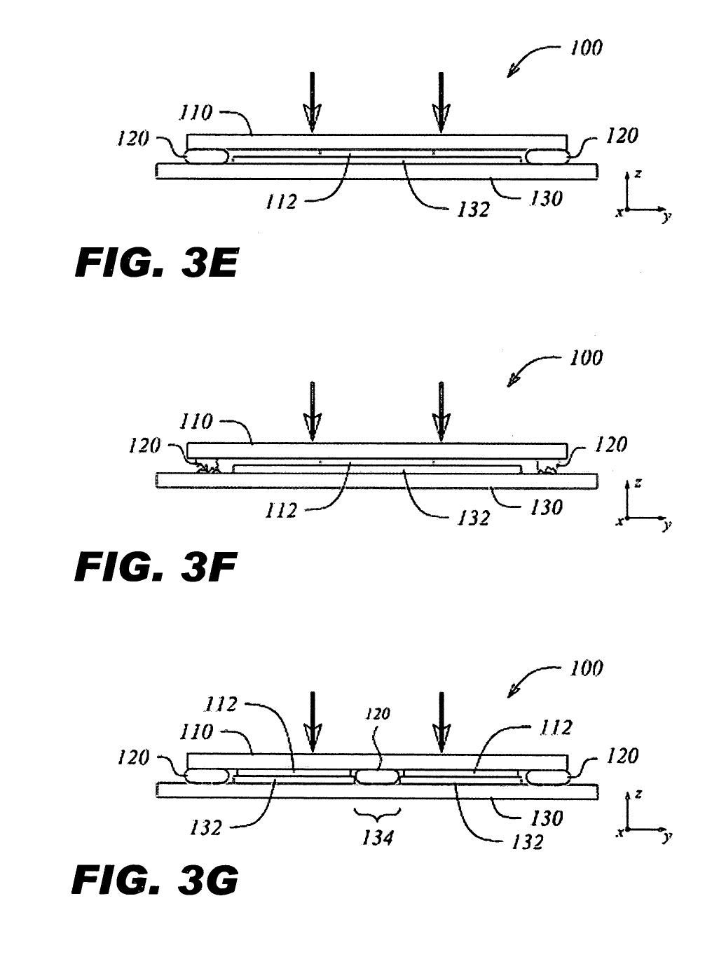

FIG. 3A illustrates a side view of the contact lithography apparatus (100) according to principles described herein. In particular, the side view illustrated in FIG. 3A depicts the contact lithography apparatus (100) in an exemplary open or initial configuration prior to initiating pattern transfer. As illustrated in FIG. 3A, the mask (110) and the substrate (130) are oriented in an x-y plane and spaced apart from one another along a z-axis direction of an exemplary Cartesian coordinate system.

Pattern transfer using the contact lithography apparatus (100) is initiated by moving the mask (110) in a z-direction toward the substrate (130), for example. The mask (110) is moved until the spacers (120) contact both of the mask (110) and the substrate (130). A z-axis oriented arrow in FIG. 3A indicates motion of the mask (110) upon pattern transfer initiation. Although not illustrated, the substrate (130) may be moved in a z-direction toward the mask (110), either instead of or in addition to the mask (110) movement, and still be within the scope of the embodiments of the present disclosure.

Once mutual contact with the spacers (120) is achieved, the spacers (120) provide an essentially parallel separation between the mask (110) and the substrate (130) as described hereinabove. Specifically, the spacers (120) act to maintain a uniform distance and proximal relationship between the mask (110) and the substrate (130) with respect to the vertical or z-axis (z) as a result of the spacing dimension of the spacers (120).

FIG. 3B illustrates a side view of the contact lithography apparatus (100) in a closed configuration according to principles described herein. In particular, FIG. 3B illustrates the contact lithography apparatus (100) after initiation of pattern transfer. As illustrated in FIG. 3B, the mask (110) and the substrate (130) are in mutual contact with the spacers (120). The uniform distance between the spaced apart mask (110) and the substrate (130) in the closed configuration is essentially a height (i.e., spacing dimension) of the spacers (120), as illustrated in FIG. 3B.

With the spacers (120) maintaining the parallel separation in the z-direction, one or both of a lateral alignment and an angular alignment (e.g., an x-y alignment and/or a rotational alignment) between the mask (110) and the substrate (130) may be accomplished. In particular, for the exemplary contact lithography apparatus (100) illustrated in FIGS. 3A and 3B, one or both of the mask (110) and the substrate (130) are moved and/or rotated in an x-y plane to accomplish alignment. Mutual contact between the substrate (130), the spacers (120) and the mask (110) is maintained during such alignment. A two-headed arrow depicted in FIG. 3B indicates aligning the mask (110) and the substrate (130) one or both of laterally and angularly.

Since the spacing dimension or height of the spacers (120) establishes the parallel alignment in the z-direction of the mask (110) and the substrate (130), such lateral alignment and/or angular alignment may be accomplished with little or no disturbance to the parallel alignment according to principles described herein. As further described hereinabove, in some embodiments, the spacing dimension (e.g., height or cross sectional diameter) of the spacers (120) is sufficient to prevent the patterned area (112) of the mask (110) from contacting or touching the target portion (132) of the substrate (130) during lateral (x-y directions) alignment and/or rotational (ω direction) alignment. In other words, clearance between the respective features of the patterned portion (112) of the mask (110) and the target portion (132) of the substrate (130) is maintained by the height of the spacers (120) during lateral alignment and/or rotational alignment.

In some embodiments, the spacers (120) comprise a material that facilitates lateral alignment between the mask (110) and the substrate (130). In particular, the spacer material is readily slideable on a contacting surface of one or both of the mask (110) and the substrate (130). The slideability of the spacers (120) on the contacting surface or surfaces enables a relative position of the mask (110) and the substrate (130) to be smoothly adjusted in the x-y and/or ω directions.

In some embodiments, the spacers (120) are fabricated from a material that produces a relatively low-friction interface at a contact point between the spacer (120) and one or both of the mask (110) and the substrate (130). The low-friction interface facilitates sliding of the spacer (120) on a surface of one or both of the mask (110) and the substrate (130) at the contact point during alignment. In some embodiments, one or both of the mask (110) and the substrate (130) or contacting portions thereof are fabricated from respective low-friction producing materials, either in lieu of or in addition to the spacers (120), depending on the embodiment. In other embodiments, a contacting surface of the spacer (120) is coated with a material that yields the low-friction interface. In other embodiments, a surface portion of one or both of the mask (110) and the substrate (130), which is contacted by the spacer (120), is coated with a respective material that yields the low-friction interface. In yet other embodiments, both a contacting surface of the spacer (120) and the contacted surface of one or both of the mask (110) and the substrate (130) are so coated with a respective low-friction producing material to facilitate slidability of the spacers (120) during alignment.

Examples of applied coating materials that may provide a low-friction interface include, but are not limited to, Teflon®, a self-assembled monolayer of a fluorinated molecule, graphite, various non-reactive metals, and various combinations of silicon, silicon dioxide, and silicon nitride. Additionally, certain lithographic resist materials including, but not limited to, nano-imprint lithography (NIL) resists, may act as a lubricant to produce the low-friction interface. Yet other exemplary applied coating materials that may provide the low-friction interface include various lubricants including, but not limited to, liquid lubricants (e.g., oils) and dry lubricants (e.g., graphite power) that may be applied to one or more of the contacting or contacted surfaces.

Pattern transfer using the contact lithography apparatus (100) is completed by bringing the patterned area (112) of the mask (110) in contact with the target portion (132) of the substrate (130). As mentioned hereinabove, in some embodiments, the contact is provided by one or both of a flexure of the mask (110) and a flexure of the substrate (130). In other embodiments, the contact is provided by a deformation (reversible or elastic, irreversible or plastic, or a combination thereof) of the spacers (120). Such a deformable spacer (120) might be constructed of one or both of a ‘passive’ deformable material (e.g., rubber, polymer or another elastomeric material) and an ‘active’ deformable material (e.g., piezoelectric actuated spacer or a thermally actuated spacer), for example, as described above. Moreover, the deformation of the spacer (120) may be controlled, in some embodiments, such as in an active deformation embodiment.

FIG. 3C illustrates a side view of the contact lithography apparatus (100) of FIGS. 3A and 3B in which flexure of the mask (110) is employed according to principles described herein. The employed flexure is sufficient to bring the mask (110) into contact with the substrate (130). In particular, the flexure of the mask (110) induces a deflection of the mask (110) sufficient to bring the patterned area (112) of the mask (110) in physical contact with the target portion (132) of the substrate (130).

FIG. 3D illustrates a side view of the contact lithography apparatus (100) of FIGS. 3A and 3B in which flexure of the substrate (130) is employed according to principles described herein. The substrate flexure serves an equivalent purpose to that of the mask flexure illustrated in FIG. 3C.

For example, when performing ultraviolet (UV)-based NIL, generally one or both of the mask (110) and the substrate (130) are UV transparent. Materials suitable for producing a UV transparent mask (110) include, but are not limited to, glass, quartz, silicone carbide (SiC), synthesized diamond, silicon nitride (SiN), Mylar®, Kapton®, other UV-transparent plastic films as well as any of these materials having additional thin films deposited thereon. Mylar® and Kapton® are register trademarks of E. I. Du Pont De Nemours and Company, Wilmington, Del. When the mask is UV transparent, the substrate (130) need not be transparent. Thus, the substrate (130) material may include silicon (Si), gallium arsenide (GaAs), aggregates of aluminum (Al), gallium (Ga), arsenic (As), and phosphorous (P) (e.g., AlₓGa₁₋ₓAs_{y}P_{1-y}), as well as various metals, plastics, and glasses. A similar but reversed set of materials may be employed in situations wherein the substrate (130) is transparent and the mask (110) is not transparent. However, it is within the scope of the various embodiments described herein for both of the mask (110) and the substrate (130) to be transparent.

In an exemplary embodiment, a gap or clearance between the mask (110) and the substrate (130) (i.e., spacer (120) spacing dimension) is approximately less than or equal to about 5 micrometers (μm), when in the closed configuration before deformation. In this exemplary embodiment, the imprint target area (132) is a square region on the substrate (130) of approximately 2.5 centimeters (cm) in extent. The spacers (120) are each located approximately 1.25 cm from an edge of the target area (132). In such an exemplary embodiment, strain calculations indicate a lateral distortion of less than 1 nanometer (nm) in the imprinted pattern may be realized.

In some embodiments, a force is applied to one or both of the mask (110) and the substrate (130) such that bending or flexing occurs in a region of one or both of the mask (110) and the substrate (130) that is delimited by the spacers (120). In other embodiments, the applied force induces a deformation of the spacers (120) such that the region(s) delimited by the spacers (120) make physical contact. In yet other embodiments, both the spacers (120) and one or both of the mask (110) and the substrate (130) are deformed and/or flexed by the applied force.

The applied force may include, but is not limited to, a hydrostatic force, a mechanical force (e.g., piezoelectrically actuated), an electromagnetic force (e.g., static and/or dynamic electric and/or magnetic force), and an acoustic force (e.g., acoustic wave and/or acoustic shock). The applied force in FIGS. 3C and 3D is indicated by large arrows oriented in a z-direction. The deformation of one or more of the mask (110), the substrate (130), and the spacer (120) is sufficient to facilitate a desired contact pressure between the patterned area (112) and the target portion (132) of the mask (110) and the substrate (130), respectively. For example, in imprint lithography, the contact pressure is sufficient to press the mask or mold (110) into a receiving surface of the substrate (130).

The force is applied after the alignment of the mask (110) and the substrate (130) is accomplished. For example, the mask (110) is moved by sliding on the spacers (120) until aligned with the substrate (130). The force is then applied to bend or flex the mask (110) and/or the substrate (130). As such, contact is achieved without disturbing the alignment. In other examples, the substrate (130) is moved instead of the mask (110), or both the substrate (130) and the mask (110) are moved relative to each other, by sliding on the spacers (120) until aligned. Moreover, in these other examples, the force may be applied to deform the spacers (120) instead of or in addition to the mask (110) and/or the substrate (130). As discussed hereinabove, the deformation may be one or more of plastic, elastic, passive or active.

In some embodiments, the flexure force may be applied by mechanical means. For example, a clamp may be used to press one or more of the mask (110), the substrate (130) and the spacer (120), thereby inducing deformation and contact between the mask (100) and the substrate (130). In other embodiments, an articulated armature may be employed to impart the flexure force. In yet other embodiments, hydrostatic pressure may be applied to produce the flexure.

Hydrostatic pressure may be applied using a hydraulic press or by way of a hydraulic bladder, for example. Alternatively, hydraulic pressure may be applied using an air pressure difference between a cavity between the mask (110) and the substrate (130) and a region surrounding the contact lithography apparatus (100). Examples of using the air pressure difference are described in co-pending patent application by Wu et al., U.S. Ser. No. 10/931,672, filed Sep. 1, 2004, incorporated herein by reference.

In some embodiments, the spacers (120) may remain intact during the flexure of one or both of the mask (110) and the substrate (130). In other embodiments, the spacers (120) may collapse or otherwise deform to a varying degree during or as a result of the application of the force that causes flexure. In such embodiments, the collapse of the spacers (120) may occur after a substantial portion of the flexure has taken place to minimize any alignment drift and/or slip that may occur during the collapse. In some of such embodiments, the spacers (120) may be made of a material that recovers or regains an initial shape or dimension after the flexure, and therefore, may be reusable (e.g., reversible or elastic deformation). For the purposes of the various embodiments, the spacer (120) may be selected from a material or a combination of materials that are one or more of rigid, semi-rigid, resilient, elastically deformable, plastically deformable, passively deformable, actively deformable, disposable and reusable, as has been described hereinabove.

FIG. 3E illustrates a side view of an embodiment of the contact lithography apparatus (100) of FIGS. 3A and 3B in which deformation of the spacer (120) is employed according to principles described herein. As illustrated in FIG. 3E, the applied force (arrows) acting through the mask induces a deformation of the spacers (120) to allow the patterned area (112) of the mask (110) to contact and press against the target portion (132) of the substrate (130) with the desired contact pressure.

FIG. 3F illustrates a side view of an embodiment of the contact lithography apparatus of FIGS. 3A and 3B in which a plastic or irreversible deformation of the spacer (120) is employed according to principles described herein. As illustrated in FIG. 3F, the applied force (arrows) acting through the mask (110) induces a plastic or facture-based deformation of the spacers (120) to allow the patterned area (112) of the mask (110) to contact and press against the target portion (132) the substrate (130) with the desired contact pressure.

FIG. 3G illustrates a side view of an embodiment of the contact lithography apparatus (100) in which deformable spacers (120) are employed according to principles described herein. In FIG. 3G, a plurality of deformable spacers (120) are located within a broader patterned area or region including, but not limited to spaces or regions 134 (e.g., streets, saw kerfs, etc.) between multiple local patterned areas (112) of the mask (110) and/or of the target portions (132) of the substrate (130). As illustrated in FIG. 3G, the applied force (arrows) acting through the mask (110) induces a deformation of the spacers (120) to allow the patterned areas (112) of the mask (1 10) to contact and press against the target portions (132) of the substrate (130) with the desired contact pressure.

While the applied force is illustrated in FIGS. 3E, 3F and 3G generally applied to the mask (110), the force may be applied to the substrate (130) in lieu of or in addition to the mask (110) and still be within the scope of the various embodiments described herein. Moreover, while the applied force is illustrated in FIGS. 3E-3G generally as centrally located arrows adjacent to the mask (110), it is within the scope of the embodiments described herein for the force to be applied anywhere along the surface of the mask (110) and/or the substrate (130), such that deformation of the spacers (120) is induced.

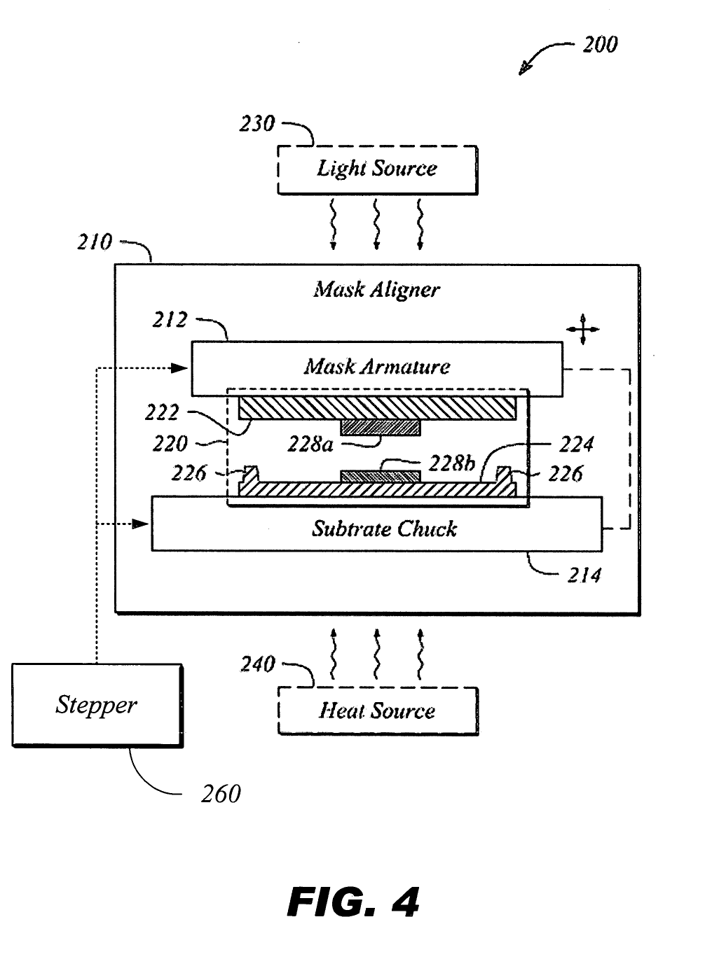

FIG. 4 illustrates a block diagram of a contact lithography system (200) according to principles described herein. In particular, the contact lithography system (200) provides for a parallel alignment, a lateral alignment and a rotational alignment between a patterning tool (e.g., photolithographic mask, imprint lithography mold, lithographic template) and a substrate to be patterned. Furthermore, the contact lithography system (200) facilitates patterning the substrate by direct contact between the patterning tool and the substrate. The facilitated patterning is accomplished through a flexure of one or more of the patterning tool, the substrate and a spacer that is between the patterning tool and the substrate, without substantially disturbing the alignment thereof. The contact lithography system (200) is applicable to any lithography methodology that involves contact between the patterning tool and the substrate being patterned including, but not limited to, photographic contact lithography, X-ray contact lithography, and imprint lithography. Hereinafter, the patterning tool is referred to as a mask for simplicity of discussion and without loss of generality.

The contact lithography system (200) comprises a contact mask aligner (210) and a contact lithography module or apparatus (220). The contact mask aligner (210) holds the contact lithography module (220) during both lateral/rotational alignments and patterning. The contact mask aligner (210) comprises a mask armature (212) and a substrate chuck, platen, or stage (214). In some embodiments, the contact mask aligner (210) may include parts of a conventional mask aligner with a substrate chuck or stage for holding a substrate and a mask armature for holding a mask. In the conventional contact mask aligner, the mask armature and the substrate chuck are movable relative to one another to enable relative lateral and rotational alignments (e.g., x-y alignment and/or angular (ω) alignment) of a mask and/or a mask blank that incorporates or holds the mask and a substrate. The contact mask aligner (210) differs from a conventional mask aligner in that the mask aligner (210) holds or supports the contact lithography module (220) for substrate patterning, which is further described below. In addition, a relative motion between the mask armature and the substrate chuck that is conventionally employed to achieve a pattern-transferring contact between the mask and the substrate is also employed in various embodiments. However, such conventional relative motion is employed in various embodiments to close the contact lithography module (220), but not for pattern transfer. Instead, a deformation in the lithography module (220) is employed to provide a pattern-transferring contact in the closed contact lithography module (220) while the mask aligner (210) maintains alignment.

The contact lithography module (220) comprises a mask blank (222), a substrate carrier (224), and one or more spacers (226). In some embodiments, the mask blank (222) comprises a flexible plate that provides a mounting surface for a patterning tool or ‘mask’ (228a). In some of such embodiments, the mask (228a) may be either flexible, semi-rigid or essentially rigid (i.e., essentially non-deformable). In such embodiments, the mask (228a) may be removably affixed to the mounting surface of the mask blank (222) using an adhesive or a means for mechanical fastening, for example, such as clamps or clips, or using a vacuum. In other embodiments, the mask blank (222) is a rigid plate or a semi-rigid plate and the mask (228a) is flexible. In such embodiments, the mask (228a) is removably affixed to a mounting surface of the mask blank (222) in a manner that facilitates flexing of the flexible mask (228a). In yet other embodiments, the mask (228a) may be formed in or is fabricated as part of the mask blank (222). In such embodiments, the mask blank (222) may be considered essentially equivalent to the mask (228a). The flexibility of the mask blank (222) and/or the mask (228a) is employed to facilitate the pattern-transferring contact in some embodiments, as described further below.

In some embodiments, the substrate carrier (224) is a rigid or semi-rigid plate that provides a mounting surface for a substrate (228b). The substrate (228b) is removably affixed to the mounting surface of the substrate carrier (224). For example, an adhesive or a mechanical fastener may be employed to affix the substrate (228b) to the substrate carrier (224). In another example, a vacuum, electromagnetic, or similar force known in the art may be employed to affix the substrate (228b) to the carrier (224).

In some embodiments, the substrate (228b) is flexible and may be affixed to the mounting surface in a manner that facilitates flexing. For example, the substrate (228b) may be affixed only around a perimeter of the substrate (228b). Alternatively, the substrate (228b) may be affixed only until flexing is needed. For example, a vacuum holding the substrate (228b) may be released or turned off to facilitate flexing.

In other embodiments, the substrate carrier (224) comprises a flexible plate to which the substrate is removably affixed. In such embodiments, the substrate (228b) may be flexible, semi-rigid or essentially rigid (i.e., essentially non-deformable). In yet other embodiments, the substrate (228b) itself may act as the substrate carrier (224). In any case, the flexibility of the substrate carrier (224) (when present) and/or the substrate (228b) is employed to facilitate the pattern-transferring contact in some embodiments.

In some embodiments, the spacers (226) are positioned between the mask blank (222) and the substrate carrier (224) outside of an area of the mask (228a) and the substrate (228b). In other embodiments, the spacers (226) are positioned within an area of the mask (228a) and the substrate (228b) (not illustrated for the system (200)). The spacers (226) are all of essentially uniform vertical spacing dimension (e.g., height or diameter) such that when the mask blank (222) and the substrate carrier (224) are brought in contact with the spacers (226), the mask blank (222) is spaced apart from and aligned (i.e., oriented) essentially parallel with the substrate carrier (224). Moreover, in the embodiments further including one or both of the mask (228a) and the substrate (228b), the mask (228a) and the substrate (228b) are aligned (i.e., oriented) essentially parallel to one another in a spaced apart relationship by virtue of being affixed to the mask blank (222) and the substrate carrier (224), respectively. In some embodiments, the spacers (226) are separately provided elements. In other embodiments, the spacers (226) are affixed to one or both of the mask blank (222) and the substrate carrier (224). In still other embodiments, the spacers (226) are fabricated as integral parts of one or both of the mask blank (222) and the substrate carrier (224).

In some embodiments, the spacers (226) are positioned between the mask (228a) and the substrate (228b) rather than between the mask blank (222) and the substrate carrier (224). Again, the spacers (226) are of uniform vertical spacing dimension (e.g., height or diameter) such that when the mask (228a) and the substrate (228b) are brought in contact with the spacers (226), the mask (228a) is spaced apart from and aligned essentially parallel and proximal with the substrate (228b). In these embodiments, the spacers (226) are located outside of a patterning area of the mask (228a) and a target portion of the substrate (228b). In some of these embodiments, the spacers (226) are separately provided elements. In other embodiments, the spacers (226) are either affixed to one or both of the mask (228a) and the substrate (228b) or fabricated as integral parts of one or both of the mask (228a) and the substrate (228b).

In some embodiments, the contact lithography module (220) is essentially similar to the contact lithography apparatus (100) described hereinabove. In such embodiments, the mask blank (222) and the mask (228a) together are essentially similar to the mask (110), while the substrate carrier (224) and the substrate (228b) are essentially similar to the substrate (130), and the spacers (226) are essentially similar to the spacers (120) described herein above with respect to the various embodiments of the contact lithography apparatus (100).

The contact mask aligner (210) initially holds the contact lithography module (220) as two separated or spaced-apart sections dictated by the relative positions of the mask armature (212) and substrate chuck (214). In particular, the mask blank (222) and the affixed mask (228a) are held by the mask armature (212) of the mask aligner (210) while the substrate carrier (224) and the affixed substrate (228b) are seated in and held by the substrate chuck (214). As described above, the spacers (226) may be affixed to either the mask blank (222), the mask (228a), the substrate carrier (224), the substrate (228b), or any combination thereof, in some embodiments. In other embodiments, the spacers (226) may be fabricated as an integral part of either the mask blank (222), the mask (228a), the substrate carrier (224), the substrate (228b), or any combination thereof. Alternatively, the spacers (226) may be merely positioned therebetween. Moreover, some of the spacers (226) may be merely positioned therebetween, while others of the spacers (226) are one or both of affixed to and fabricated integrally with one or more of the mask blank (222), the mask (228a), the substrate carrier (224), the substrate (228b), or any combination thereof. When held by the mask aligner (210) as spaced apart sections, the contact lithography module (220) is said to be ‘open’.

In some examples, it is desired to transfer a pattern from the patterning tool to each of a number of different portions of a substrate. The substrate can then be cut to divide those separately patterned portions into a number of identical units. As shown in FIG. 4, the contact lithography system (200) may also include a stepper (260). As will be described in more detail below, the stepper (260) repositions either or both of the mask armature (212) and the substrate chuck (214) after each of a number of lithography cycles so that the pattern on the mask (228a) can be transferred repeatedly to different portions of the substrate (228b). The substrate (228b) is then divided to produce a number of identical units. The stepper (260) may be part of or separate from the mask alignment system (210). Typically, once the mask (228a) and substrate (228b) are aligned, the stepper (260) can operate without the need for additional alignment operations.

If there are multiple lithographic cycles in which a pattern on a patterning tool is transferred repeatedly to different portions of a receiving substrate, the process is referred to as a step-and-repeat process. In the following paragraphs, a number of different systems and methods will be described in which step-and-repeat lithography is used to transfer a single pattern from a patterning tool to multiple locations on a receiving substrate.

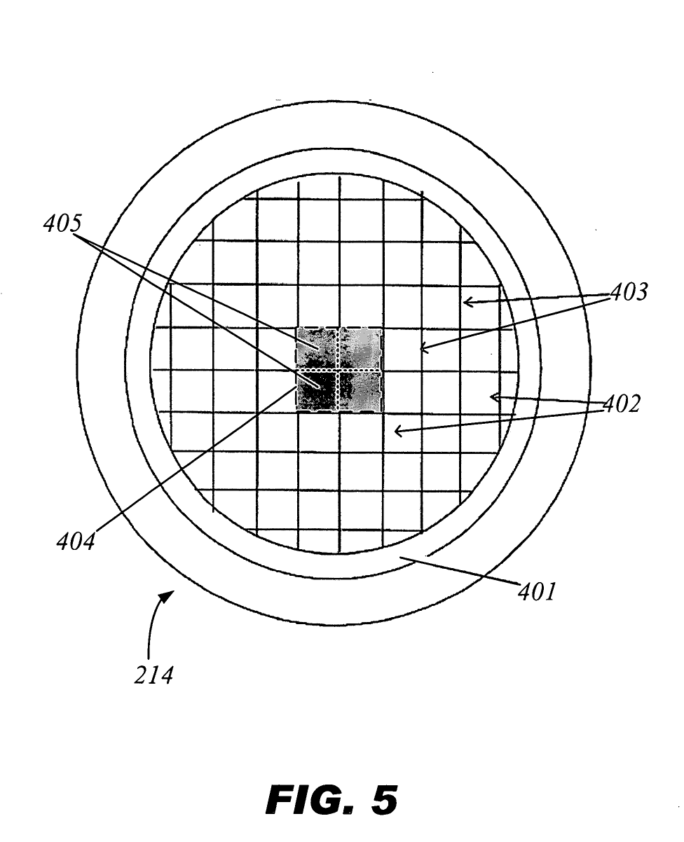

FIG. 5 illustrates a substrate chuck of a contact lithography device for performing one exemplary step-and-repeat lithography process. As discussed above, a substrate chuck (214), such as that illustrated in FIG. 4, is used to hold a substrate, e.g., a wafer, that is undergoing contact lithography. The substrate secured on the chuck (214) may be referred to as a “chucked substrate.”

As shown in FIG. 5, a substrate or wafer chuck (214) can be configured to selectively contact portions of the chucked substrate with a patterning tool to perform contact lithography on each such specific individual portion of the chucked substrate. This patterning tool is then stepped to another individual portion of the chucked substrate and the process is repeated. Thus, this step-and-repeat lithography process produces a number of identical patterns on the substrate. The substrate is then cut or divided to separate the individual patterns into separate units.

As shown in FIG. 5, the surface of the substrate chuck (214) is divided into a number of compartments or zones (402). Each zone (402) is surrounded by an air-tight seal (403). The seal (403) contacts the underside of a chucked substrate to separate and seal each of the individual zones (402) of the chuck (214) so that a vacuum or a pressure can be separately applied to, or created in, each individual zone (402).

To chuck a substrate, all of the zones (402) can be evacuated to produce a vacuum that collectively holds a substrate against the chuck (214). Additionally, other measures may also be employed to secure a substrate to the chuck (214). A chuck seal (401) surrounds the area of the individual zones (402) and also contacts the underside of a chucked substrate to seal the entire interior, including the zones (402), of the underside of the chucked substrate.

In the example of FIG. 5, four of the zones (402) of the wafer chuck (214) correspond to portion of the substrate that is sized to receive a pattern from the patterning tool during contact lithography. However, any number of the zones (402) could correspond to the size of the pattern being transferred. Thus, in FIG. 5, a region (404) of the chuck surface includes four individual zones (405) and corresponds to a portion of the chucked substrate that is to be individually subjected to lithography in a particular cycle without involving surrounding portions of the chucked substrate.

This is accomplished, for example, by first evacuating the space between the patterning tool and the chucked substrate. Then, the zones (405) of the region (404) of the chuck (214) where the lithography is to occur are vented to atmosphere or some greater pressure. As a result, the portion of the chucked substrate above the region (404) will be deflected upward by the pressure difference between the vented zones (405) and the vacuum above the substrate. This brings that portion of the substrate into contact with the patterning tool, and lithography on that portion of the substrate can be performed. In some embodiments, as will be explained below, an area above the substrate corresponding to the region (405) is further vacuumed before or during the operation to facilitate the lithography.

As will be appreciated by those skilled in the art, the structure and functionality described above with respect to the substrate chuck (214) could also be provided in a patterning tool, e.g., a mask blank, for the same purposes. Thus, it may be a deformable patterning tool that is backed by the zones that can be vacuumed or pressurized individually.

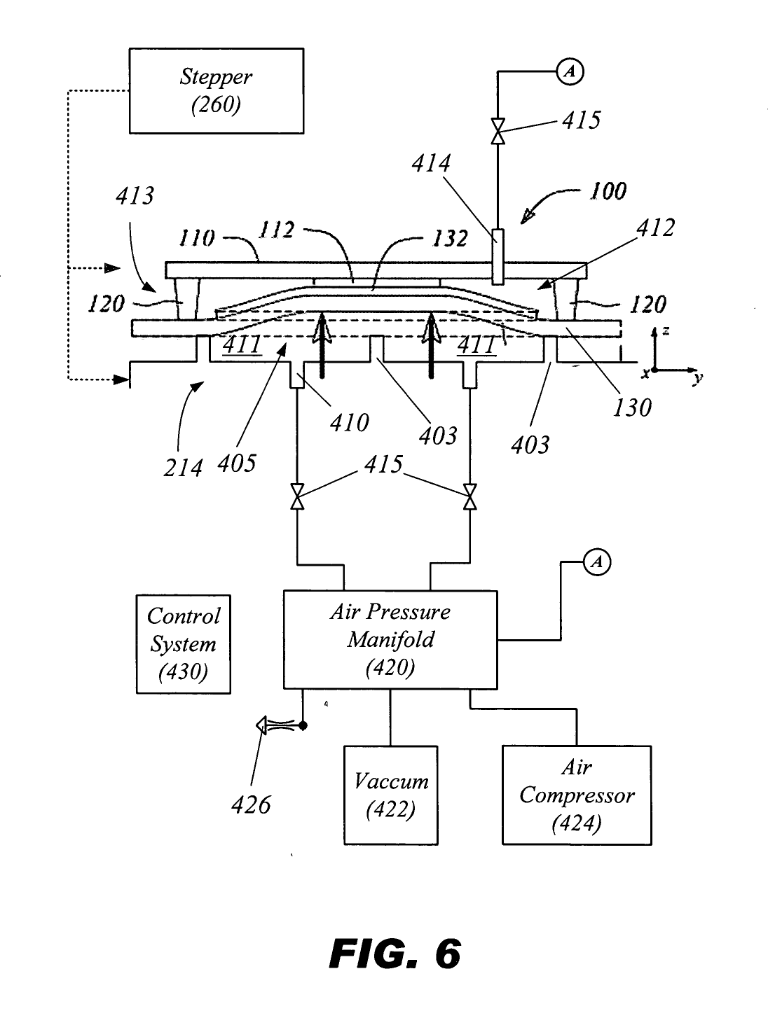

FIG. 6 illustrates a cross section view of an exemplary operation of the contact lithography device shown in FIG. 5 according to principles described herein. Further to the discussion above with respect to FIG. 5, FIG. 6 illustrates a portion (132) of the chucked substrate (130) that is selectively deflected to come into contact with a patterned area (112) of the pattering tool (110). Other portions of the substrate (130) remain out of contact with the patterning tool (110). Consequently, the pattern of the patterned area (112) can be selectively transferred to a specific portion of the substrate (130) during each lithography cycle.

As above, the wafer chuck (214) is divided into separate zones by the seals (403). The seals (403) may, for example, define the zones as a square or rectangular grid, such as that shown in FIG. 5. Specific zones (405) on the chuck (214) underlay the portion (132) of the substrate (130) that is to be brought into contact with the patterning tool (110) for a particular lithography cycle.

In the example of FIG. 6, an air passage (410) for each of the zones (405) is separately connected through a valve (415) to an air pressure manifold (420). The air pressure manifold (420), as will be described in more detail below, is connected to a vacuum (422) and air compressor (424) and a vent (426). Thus, if a valve (415) for a particular zone is open, the air pressure manifold (420) can vent the zone (405) to atmospheric pressure, evacuate the zone (405) or even pressurize the zone (405) using the air compressor (424). A control system (430) is provided that controls all the valves (415), the air pressure manifold (420), vent (426), vacuum (422) and air compressor (424) according to the principles and methods described herein. The pressure manifold (420) may also include buffer tanks for vacuum and pressure to help isolate the vacuum (422) and air compressor (424). Buffer tanks also isolate vibrations

Initially, the zones (405) may be evacuated using the vacuum (422). A vacuum in one or more zones (405) helps to secure the substrate (130) to the chuck (214). Once the vacuum is established, the valves (415) for those zones (405) are closed to maintain the vacuum.

When a lithography cycle is to be performed, the area (413) between the patterning tool (110) and the substrate (130) is evacuated. This may be performed through an air passage (414) that is also coupled, through a valve (415), to the air pressure manifold (420) and the vacuum (422). Then, the volume (411) contained in each of the zones (405) that underlay the portion (132) of the substrate (130) to be patterned is vented to atmosphere or some greater pressure. This may be performed by opening the respective valves (415) corresponding to those zones (405) and connecting each such volume through its air passage (410) and the manifold (420) to the vent (426). Each volume (411) has its own respective air passage (410) so that, as described above, each zone (405) can be individually and independently vented, pressurized or evacuated as needed.

As shown in FIG. 6, venting the volumes (411) causes a corresponding portion (132) of the substrate (130) to deflect upward into the vacuum between the patterning tool (110) and the substrate (130) and into contact with the patterned area (112) of the patterning tool (110). Contact lithography is then performed to transfer the pattern from the area (112) of the patterning tool (110) to the corresponding portion (132) of the substrate (130). This lithography may be, for example, imprint or photographic lithography.

Additionally, with the air passage (414) on the patterning tool (110), the area (412) that is under the patterning tool (110), between the spacers (120) and above the substrate (130) can be further evacuated before and/or during the lithography cycle to maintain or increase the pressure between the patterned area (112) and the portion (132) of the substrate (130) being patterned.

As mentioned, this entire process can be repeated to form additional patterned units on other portions of the substrate (130). The stepper (260) repositions either or both of the patterning too (110) or the substrate (130) to align the patterned surface (112) with a new portion of the substrate (130) that is to be patterned. In this step-and-repeat process, a number of identical patterns are formed by the patterning tool on different portions of the substrate (130). The substrate (130) can then, in some examples, be divided or cut up to produce a corresponding number of identical units.

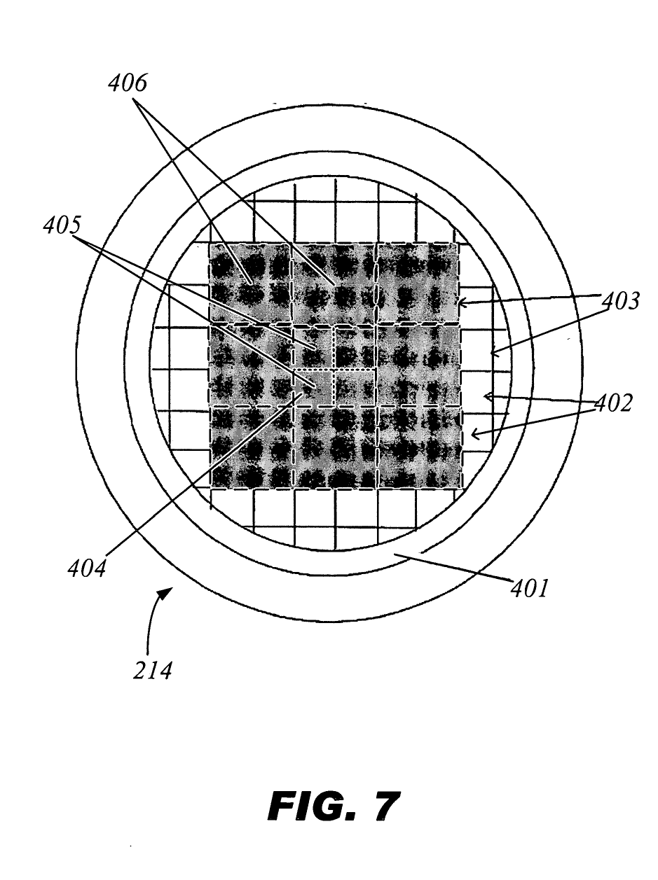

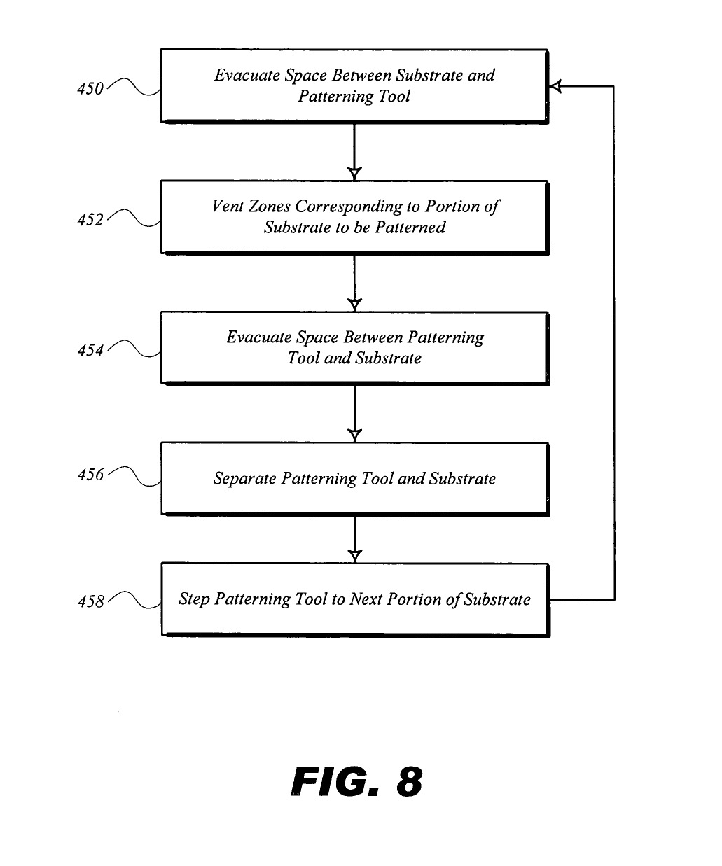

FIG. 7 further illustrates these principles. As shown in FIG. 7, after lithography has been performed on a first portion of the substrate using a first region (404) of the chuck (214), the chuck (214) and/or the patterning tool is repositioned to align another portion of the substrate and corresponding region (e.g., 406) of the chuck (440) with the patterned area (112, FIG. 6) of the patterning tool. The newly-aligned portion of the substrate is brought into contact with the patterning tool, for example, by venting the zones underneath that portion. Lithography is then again performed, in the manner described above, using that portion of the substrate and corresponding region of the chuck (214).

This step-and-repeat procedure is repeated until all desired portions of the chucked substrate have lithographically received the pattern from the patterning tool. In the example of FIG. 7, there are nine regions (404, 406) of the chuck (214) that correspond to nine such portions of the substrate.

FIG. 8 illustrates a flow chart of an exemplary method of step-and-repeat contact lithography according to principles described herein. Initially, the substrate and patterning tool, e.g., a mask, must be properly aligned. There are many methods and system for aligning the substrate and patterning tool, any of which can be used with the principles described herein.

After alignment, as shown in FIG. 8, the space between the substrate and the patterning tool is evacuated (step 450). Then, the zones of the substrate chuck that underlay a portion of the substrate to be patterned are vented (step 452) causing that portion of the substrate to deflect into the vacuum above the substrate and into contact with the patterning tool. Further evacuation of the space between the substrate and the patterning tool may be performed (step 454) before and/or during the lithography cycle to maintain or increase the pressure between the patterning tool and the substrate.

After lithography on that portion of the substrate has been performed, the patterning tool and substrate are separated (step 456). If imprint lithography is being used, the separation of the substrate and patterning tool may be facilitated by an application of force, as will be described in more detail below. Then, the patterning tool and/or the substrate chuck is repositioned to align the patterning tool with a next portion of the substrate to be patterned (step 458). Following this stepping of the patterning tool to pattern the next portion of the substrate, the method of FIG. 8 is then repeated. This step-and-repeat continues until all desired portions of the substrate have been lithographically patterned.

Returning to the step of separating the patterning tool and substrate (step 456), some care may be needed to separate the patterning tool and substrate. If any lateral force is applied in separating the two, damage may result to the tiny and delicate structures formed on the substrate.

As shown in FIG. 6, the substrate (130) is deflected upward out-of-plane to contact the patterning tool (110). As described, the substrate (130) is drawn into this position by a vacuum between the substrate (130) and the patterning tool (110). When this vacuum is released, e.g., by opening the valve (415) and connecting the space (412) through the manifold (420) to the vent (426), the substrate (130) will naturally tend to return to its original planar configuration, pulling away from the patterned surface (112) of the patterning tool (110).

However, in some instances, this may be insufficient to separate the substrate (130) and the patterning tool (110). In other instances, the substrate (130) may adhere more strongly to particular portions of the patterned surface (112) than others. For example, the substrate (130) may adhere more tightly to a more densely patterned portion of the patterning tool (110) that presents a greater surface area in contact with the substrate (130) than other portions of the patterned surface (112). If this is the case, the substrate (130) may pull away from the patterned surface (112) unevenly introducing the possibility of lateral forces that may damage the patterned structure on the substrate (130).

To address these issues, the valve (415) of the air passage (414) may be opened, and the air compressor (424) may force air into the space (412) between the patterning tool (110) and the substrate (130). This air pressure will tend to separate the patterning tool (110) from the substrate (130), urging the substrate (130) back to its planar configuration. Because this air pressure acts in all directions simultaneously, it will tend to separate the patterning tool (110) and substrate (130) without lateral forces that could damage structures patterned on the substrate (130).

Additionally or alternatively, the valves (415) corresponding to the zones (405) of the substrate chuck (214) under the deflected portion (132) of the substrate (130) can be opened, and those zones (405) evacuated using the vacuum (422) through the manifold (420). This vacuum will further tend to separate the substrate (130) and the patterning tool (110) as the substrate (130) is pulled by the vacuum back toward its planar configuration. Again, because air pressure acts in all directions simultaneously, it will tend to separate the patterning tool (110) and substrate (130) without lateral forces that could damage structures patterned on the substrate (130).

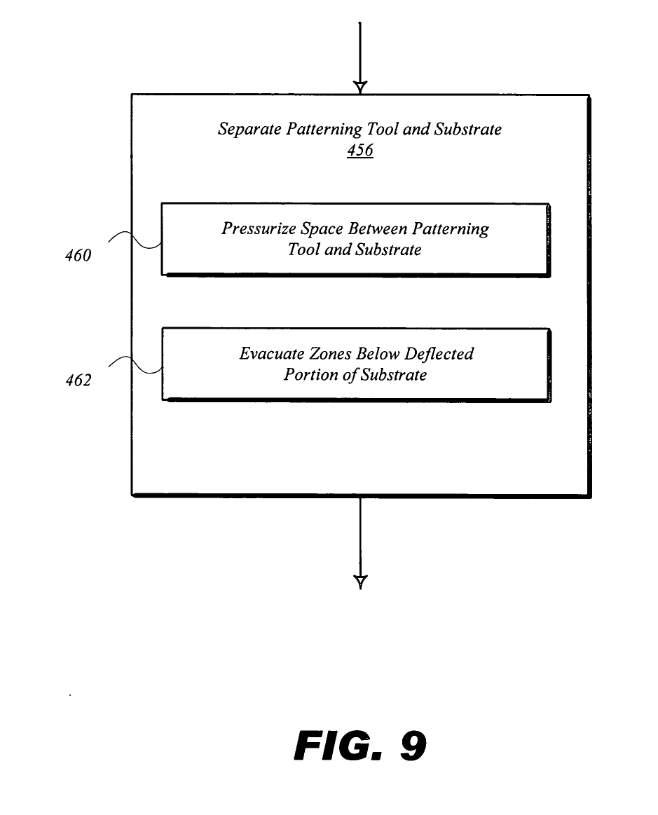

This method is illustrated in FIG. 9. FIG. 9 illustrates a flow chart of an exemplary method of separating a patterning tool and substrate following contact lithography according to principles described herein. As shown in FIG. 9, the separation of the patterning tool and substrate (step 456) may include either or both of pressurizing the space between the patterning tool and the substrate (step 460) and evacuating the zones below the deflected portion of the substrate (step 462). As described above, separation of the patterning tool and substrate in this manner minimizes the possibility of damage occurring as a result of the separation to the delicate structures formed on the substrate.

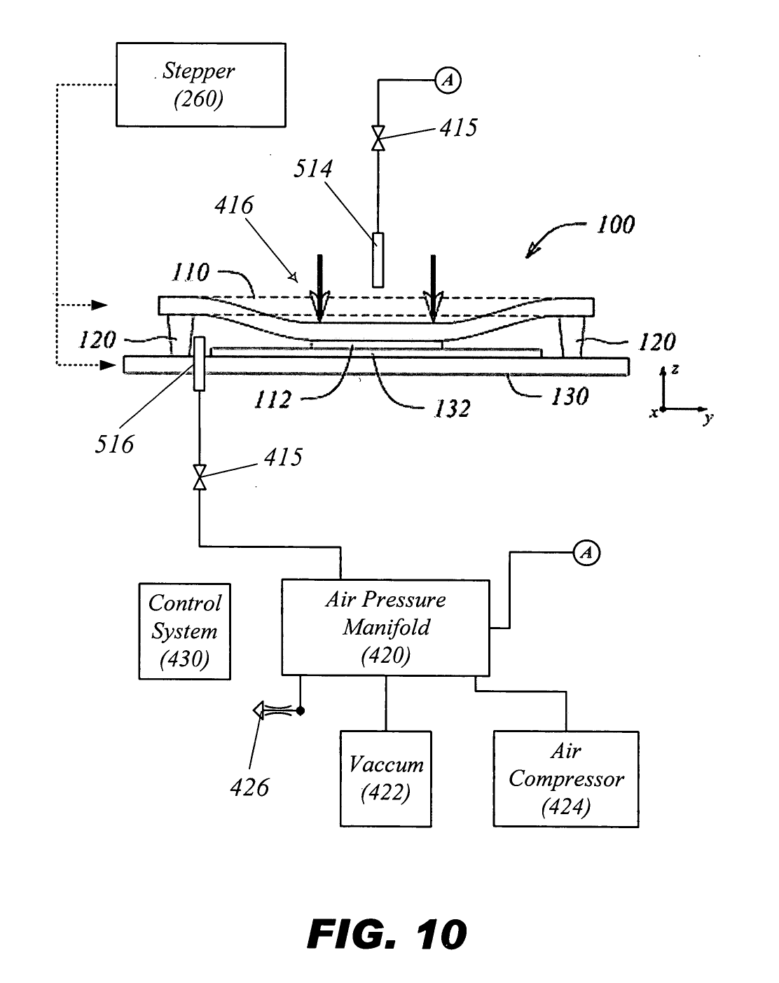

FIG. 10 illustrates another exemplary contact lithography device for performing a step-and-repeat lithography process to produce a number of identical units from a single substrate according to principles described herein. As mentioned above, contact lithography can also be performed by deforming the patterning tool (e.g., a mask or mold) to contact a planar substrate. This alternative is now described in the context of a step-and-repeat lithography system.

As shown in FIG. 10, the patterning tool (110) deflects downward to bring a patterned surface (112) into contact with a surface portion (132) of a chucked substrate (130) that is to be patterned. That portion of the substrate (130) is then lithographically patterned.

Similar to the systems described above, the stepper (260) or similar system then repositions either or both of the patterning tool (110) and the substrate (130) to align the patterned surface (112) of the patterning tool (110) with a new portion of the substrate (130) that is to receive the pattern. In this way, the pattern (112) on the patterning tool (110) can be transferred repeatedly to different portions of the substrate (130). The substrate (130) can then be divided to produce a number of identical units.

The patterning tool (110) can be deflected into contact with the substrate (130) in a number of ways. In some examples, the patterning tool (110) can be deflected into contact with the substrate (130) by a mechanical force. In the illustrated example, an air passage (514) into a space behind the patterned surface (112) on the patterning tool (110) can be connected through an open valve (415) to the air compressor (424). The air compressor (424) pressurizes the air in that space behind the patterned surface (112) on the patterning tool (110) to deflect the patterned surface (112) into contact with a specific portion (132) of the substrate (130).

Additionally or alternatively, an air passage (516) can be connected through a valve (415) to the vacuum (422). The vacuum (422) then evacuates the area between the patterning tool (110) and the substrate (130). This vacuum will further urge the patterned surface (112) of the patterning tool (110) into contact with the designated portion (132) of the substrate (130).

To separate the patterning tool (110) and the substrate (130), this process can be reversed, with the vacuum (422) evacuating the space behind the patterning tool (110) through the air passage (514), and the air compressor (424) pressurizing the space between the patterning tool (110) and the substrate (130) through the air passage (516).

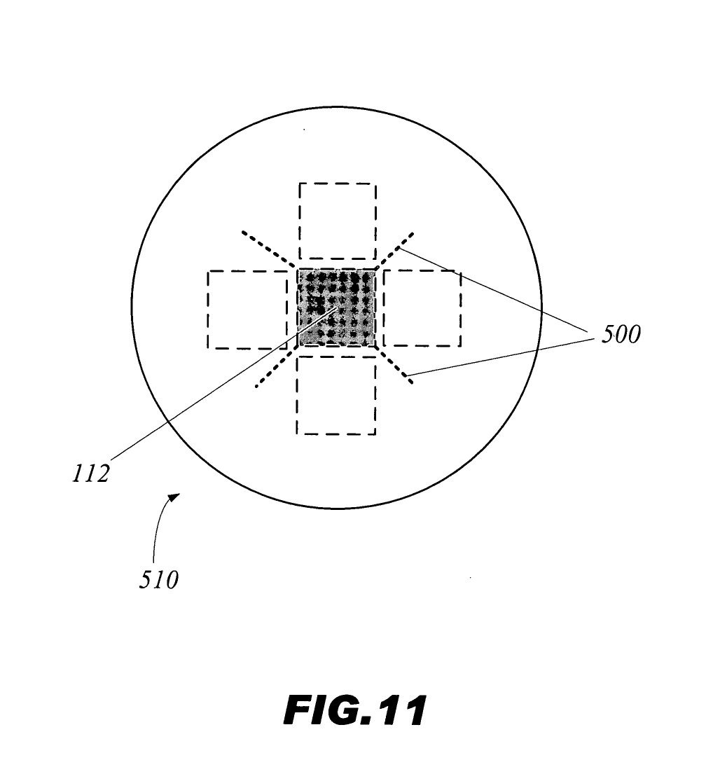

FIG. 11 illustrates an exemplary patterning tool for use in a step-and-repeat contact lithography process according to principles described herein. In the system described above in connection with FIG. 10, only one portion of the patterning tool, that portion bearing the patterned surface, needs to deflect into contact with the substrate. This is in contrast to the system described above in which different portions of the substrate are selectively deflected into contact with the patterning tool. Because only one portion of the patterning tool needs to deflect, the patterning tool can be made with features that localize the strain required to deflect that portion bearing the patterned surface.

As shown in FIG. 11, an exemplary patterning tool (510) includes a patterned surface (112) that bears a pattern to be lithographically transferred to a substrate. Around the patterned surface (112), the patterning tool (610) comprises features (500) that localize the strain associated with deflecting the patterned surface (112) into contact with a substrate. These features (500) may be folds, seams, flex lines, etchings, cuts or any other feature that facilitates the deflection of the patterned surface (112) of the tool (510) out of its normal plane and into contact with a substrate.

An additional benefit of the features (500) is that they help ensure that the patterned surface moves only in a linear direction toward or away from the substrate being patterned and not laterally. As noted above, lateral movement, particularly during the separation of the patterned surface (112) from the substrate, can potentially result in damage to the structures formed on the substrate. Also, in an imprint lithography system, distortion of the imprint field during imprinting is minimized by the flex features (500).

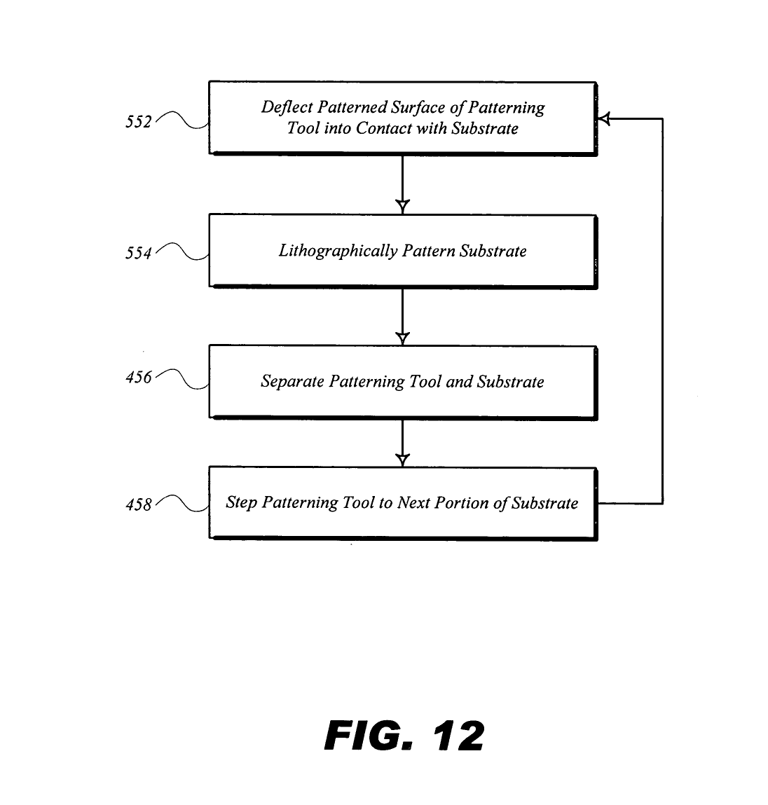

FIG. 12 illustrates a flow chart of this exemplary method of operating the contact lithography system of FIG. 10. As shown in FIG. 12, after alignment of the patterning tool and substrate, the patterned surface of the patterning tool is deflected into contact with the substrate (step 552). The substrate is then lithographically patterned (step 554) and the patterning tool and substrate are separated (456). The separation may be performed using the principles described above.

The patterning tool is then stepped by repositioning either or both of the patterning tool and the substrate to align the patterning tool with a next portion of the substrate to be patterned (step 458). The method of FIG. 12 is then repeated, following this stepping of the patterning tool, to pattern the next portion of the substrate. This step-and-repeat continues until all desired portions of the substrate have been lithographically patterned.

The preceding description has been presented only to illustrate and describe examples of the principles discovered by the applicants. This description is not intended to be exhaustive or to limit these principles to any precise form or example disclosed. Many modifications and variations are possible in light of the above teaching.

What is claimed is:

1. A contact lithography system comprising:
a patterning tool bearing a pattern;
a substrate chuck for chucking a substrate to receive said pattern from said patterning tool;
wherein said system deflects a portion of either said patterning tool or said substrate to bring said patterning tool and a portion of said substrate into contact; and
a stepper for repositioning either or both of said patterning tool and substrate to align said pattern with an additional portion of said substrate to also receive said pattern.

2. The system of claim 1, wherein said substrate chuck selectively deflects portions of said substrate into contact with said patterning tool.

3. The system of claim 2, wherein said substrate chuck comprises a plurality of sealed zones, each of which can be selectively evacuated or vented to selectively deflect portions of said substrate into contact with said patterning tool.

4. The system of claim 3, further comprising an air pressure manifold fluidly coupled with each of said sealed zones and with a vent and vacuum.

5. The system of claim 2, further comprising a vacuum for evacuating a space between said patterning tool and substrate to facilitate said selectively deflection of portions of said substrate into contact with said patterning tool.

6. The system of claim 1, further comprising an air compressor for pressurizing an area between said patterning tool and substrate to separate said patterning tool and substrate.

7. The system of claim 1, further comprising an armature that deflects said patterning tool to bring said pattern into contact with said substrate.

8. The system of claim 7, further comprising an air compressor for applying air pressure to deflect said patterning tool to bring said pattern into contact with said substrate.

9. The system of claim 7, further comprising a vacuum for evacuating a space between said patterning tool and said substrate to deflect said patterning tool to bring said pattern into contact with said substrate.

10. The system of claim 7, wherein said patterning tool comprises features that localize stress caused by the deflection of a portion of said patterning tool bearing said pattern into contact with said substrate.

11. A method of performing contact lithography comprising:
deflecting a portion of either a patterning tool or a substrate to bring said patterning tool and a portion of said substrate into contact; and
repositioning either or both of said patterning tool and substrate to align a pattern on said patterning tool with an additional portion of said substrate to also receive said pattern.

12. The method of claim 11, further comprising selectively deflecting portions of said substrate into contact with said patterning tool.

13. The method of claim 12, further comprising evacuating and then venting one or more sealed zones of a substrate chuck to selectively deflect a portion of said substrate into contact with said patterning tool.

14. The method of claim 12, further comprising evacuating a space between said patterning tool and substrate to facilitate said selectively deflection of portions of said substrate into contact with said patterning tool.

15. The method of claim 11, further comprising deflecting a portion of said patterning tool to bring said pattern into contact with said substrate.

16. The method of claim 15, further comprising applying air pressure to deflect said patterning tool to bring said pattern into contact with said substrate.

17. The method of claim 15, further comprising evacuating a space between said patterning tool and said substrate to deflect said patterning tool to bring said pattern into contact with said substrate.

18. A method of separating a patterning tool and substrate after a lithographic cycle of a contact lithography system, said method comprising pressurizing an area between said patterning tool and substrate to separate said patterning tool and substrate.

19. The method of claim 18, further comprising evacuating a space behind either said patterning tool or said substrate to facilitate separation of said patterning tool and substrate.

20. A contact lithography system comprising:
a patterning tool bearing a pattern;
a substrate chuck for chucking a substrate to receive said pattern from said patterning tool;
means for deflecting a portion of either said patterning tool or said substrate to bring said patterning tool and a portion of said substrate into contact; and
means for repositioning either or both of said patterning tool and substrate to align said pattern with an additional portion of said substrate to also receive said pattern.
